(19) United States
(12) Patent Application Publication
(10) Pub. No.: US 2020/0031713 A1
(43) Pub. Date: Jan. 30, 2020

(54) METHOD FOR REFORMING UNBURNT-CARBON-CONTAINING FLY ASH, SYSTEM FOR REFORMING UNBURNT-CARBON CONTAINING FLY ASH, AND METHOD FOR PRODUCING FLY ASH FOR CONCRETE ADMIXTURE

(71) Applicant: MITSUBISHI MATERIALS CORPORATION, Chiyoda-ku, Tokyo (JP)

(72) Inventors: Makio YAMASHITA, Chichibu-gun (JP); Koota DOI, Tokyo (JP)

(73) Assignee: MITSUBISHI MATERIALS CORPORATION, Chiyoda-ku, Tokyo (JP)

(21) Appl. No.: 16/498,190

(22) PCT Filed: Mar. 19, 2018
(86) PCT No.: PCT/JP2018/010763

§ 371 Date: Sep. 26, 2019

(30) Foreign Application Priority Data
Mar. 31, 2017 (JP) 2017-073123

(51) Int. Cl. C04B 7/26; C04B 7/36; C04B 7/44; B07C 5/342

(52) U.S. Cl. CPC C04B 7/26; C04B 7/362; B07C 2501/0054; B07C 5/3425; C04B 7/4407

(57) ABSTRACT

There is provided a method for reforming unburned carbon-containing coal ash of the present invention, including: a receiving process of measuring L value and b value of unburned carbon-containing coal ash in a Lab color order system and sorting unburned carbon-containing coal ash of which the L value is 54 or more and the b value is 2 or more and 10 or less; and a classifying process of classifying the unburned carbon-containing coal ash sorted in the receiving process under a condition that a residue on a 45 μm sieve of reformed coal ash which has been reformed by classification is 8% by mass or less.

### TECHNICAL FIELD

The present invention relates to a method for reforming unburned carbon-containing coal ash, a system for reforming unburned carbon-containing coal ash, and a method for producing fly ash for use in concrete.

Priority is claimed on Japanese Patent Application No. 2017-073123, filed on Mar. 31, 2017, the content of which is incorporated herein by reference.

### BACKGROUND ART

It is studied to use coal ash (also referred to as fly ash) generated at a coal-fired thermal power plant, a fluidized bed combustion furnace, or the like as a concrete admixture. Fly ash for use in concrete is defined in Japanese Industrial Standard JIS A 6201 (fly ash for use in concrete). However, coal ash generally contains unburned carbon, and the unburned carbon may adsorb components of a chemical admixture such as an AE (air-entraining) admixture, an AE (air-entraining) and water reducing admixture, and a water reducing admixture. Therefore, when the amount of the unburned carbon of coal ash to be added to concrete is large, it may be necessary to increase the addition amount of chemical admixture such as the AE admixture, the AE water reducing agent, and the water reducing agent. In addition, when coal ash having a large amount of unburned carbon is added to concrete, an air content or fluidity of the concrete may fluctuate or black spots due to the unburned carbon may be generated on a surface of hardened concrete, and thus an appearance may be worse.

Therefore, methods for removing the unburned carbon in the unburned carbon-containing coal ash are studied. For example, Patent Document 1 describes a method in which unburned carbon-containing coal ash is pulverized and then classified and pulverized unburned carbon is removed. Patent Documents 2 and 3 describe a method of removing unburned carbon by using static electricity. Patent Document 4 describes a method of removing unburned carbon in coal ash by firing.

In addition, Patent Document 5 describes that coal ash is effectively used in a manner that coal ash is distributed to a plurality of storage facilities according to a chemical composition or fineness, and fly ash according to a required quality is supplied by performing classification processing as needed.

### CITATION LIST

### Patent Literature

[Patent Document 1] Japanese Unexamined Patent Application, First Publication No. 2010-30885

[Patent Document 2] Japanese Unexamined Patent Application, First Publication No. 2006-150231

[Patent Document 3] Japanese Unexamined Patent Application, First Publication No. 2005-305344

[Patent Document 4] Japanese Unexamined Patent Application, First Publication No. H8-243526

[Patent Document 5] Japanese Unexamined Patent Application, First Publication No. 2005-313165

### DISCLOSURE OF INVENTION

### Technical Problem

However, it is difficult to completely remove the unburned carbon only by pulverization and classification described in Patent Document 1. In addition, in the method using the static electricity described in Patent Documents 2 and 3, since not only unburned carbon but also positively charged fine particles are removed, there is a concern that highly active glassy particles may be removed to lose activity. In addition, in the method of removing the unburned carbon by firing disclosed in Patent Document 4, fuel cost is high, and activity of coal ash is reduced due to firing, and thus there is a concern that use as fly ash for use in concrete may be difficult. In addition, as described in Patent Document 5, in the method of storing coal ash in the storage facilities, since a large number of storage facilities are required, a large area is required, and in a case where balance between stored coal ash and demand is not appropriate, there is a concern that it may be necessary to dispose of coal ash which is not effectively used.

The present invention was made in view of the above points, and an object thereof is to provide a method for reforming unburned carbon-containing coal ash and a system for reforming unburned carbon-containing coal ash, which can reform unburned carbon-containing coal ash generated at a coal-fired thermal power plant or the like as coal ash, which can be effectively used as fly ash for use in concrete as defined in JIS A 6201, by using a relatively simple apparatus. In addition, another object of the present invention is to provide a method for producing fly ash for use in concrete, which can reform the unburned carbon-containing coal ash generated at the coal-fired thermal power plant into fly ash for use in concrete by using a relatively simple apparatus.

### Solution to Problem

In order to solve the above problems, according to an aspect of the present invention, there is provided a method for reforming unburned carbon-containing coal ash, including: a receiving process of measuring L value and b value of unburned carbon-containing coal ash in a Lab color order system and sorting unburned carbon-containing coal ash of which the L value is 54 or more and the b value is 2 or more and 10 or less; and a classifying process of classifying the unburned carbon-containing coal ash sorted in the receiving process under a condition that a residue on a 45 μm sieve of reformed coal ash which has been reformed by classification is 8% by mass or less.

According to the method for reforming unburned carbon-containing coal ash, which is the aspect of the present invention having this configuration, the unburned carbon-containing coal ash of which the L value is 54 or more and the b value is 2 or more and 10 or less is sorted and used. Therefore, the reformed coal ash has a low methylene blue (MB) adsorption amount and a high activity index. In addition, in the method for reforming unburned carbon-containing coal ash, which is the aspect of the present invention, the sorted unburned carbon-containing coal ash is classified under the condition that the residue on a 45 μm sieve of the reformed coal ash which has been reformed by classification is 8% by mass or less. Therefore, coarse coal ash in which an attached amount of the unburned carbon is large is efficiently removed. Therefore, since the reformed coal ash is fine and has a high activity index, it is possible to effectively use the reformed coal ash as fly ash for use in concrete. Accordingly, coal ash which can be effectively used as the fly ash for use in concrete can he obtained by a relatively simple apparatus without using means for using electricity or heating.

Here, in the method for reforming unburned carbon-containing coal ash, which is the aspect of the present invention, the unburned carbon-containing coal ash may be unburned carbon-containing coal ash generated at a coal-fired thermal power plant.

In this case, the unburned carbon-containing coal ash generated at the coal-fired thermal power plant in a large amount can be effectively used.

In addition, in the method for reforming unburned carbon-containing coal ash, which is the aspect of the present invention, in the classifying process, it is preferable that the unburned carbon-containing coal ash is classified under a condition that the residue on a 45 μm sieve of the reformed coal ash which has been reformed by classification is 5% by mass or less.

In this case, the residue on a 45 μm sieve of the reformed coal ash is 5% by mass or less. Therefore, reformed coal ash is fine and surely has a high activity index. Accordingly, it is possible to more effectively use the reformed coal ash as fly ash for use in concrete.

According to another aspect of the present invention, there is provided a system for reforming unburned carbon-containing coal ash, including: a receiving unit that is configured to measure L value and b value of unburned carbon-containing coal ash in a Lab color order system and sorts unburned carbon-containing coal ash of which the L value is 54 or more and the b value is 2 or more and 10 or less; and a classifying apparatus that is configured to classify the unburned carbon-containing coal ash sorted by the receiving unit under a condition that a residue on a 45 um sieve of reformed coal ash which has been reformed by classification is 8% by mass or less.

According to the system for reforming unburned carbon-containing coal ash, which is the aspect of the present invention having this configuration, the receiving unit that sorts the unburned carbon-containing coal ash of which the L value is 54 or more and the b value is 2 or more and 10 or less and the classifying apparatus that performs classification under the condition that the residue on a 45 μm sieve of the reformed coal ash which has been reformed by classification is 8% by mass or less are provided. Therefore, reformed coal ash which can be effectively used as fly ash defined in HS A 6201 can be obtained by a simple method without performing electrostatic force or heating.

According to still another aspect of the present invention, there is provided a method for producing fly ash for use in concrete, by reforming unburned carbon-containing coal ash generated at a coal-fired thermal power plant, in which a method for reforming the unburned carbon-containing coal ash is the method for reforming unburned carbon-containing coal ash, which is the aspect of the present invention described above.

According to the method for producing fly ash for use in concrete which is the aspect of the present invention having this configuration, the method for reforming unburned carbon-containing coal ash which is the aspect of the present invention described above is used as a method for reforming unburned carbon-containing coal ash. Therefore, unburned carbon-containing coal ash generated at a coal-fired thermal power plant can be made fly ash for use in concrete by using a relatively simple apparatus.

### Advantageous Effects of Invention

According to the present invention, it is possible to provide a method for reforming unburned carbon-containing coal ash and a system for reforming unburned carbon-containing coal ash, which can reform unburned carbon-containing coal ash generated at a coal-fired thermal power plant or the like as coal ash, which can be effectively used as fly ash for use in concrete as defined in JIS A 6201, by using a relatively simple apparatus. In addition, according to the present invention, it is possible to provide a method for producing fly ash for use in concrete, which can reform the unburned carbon-containing coal ash generated at the coal-fired thermal power plant into fly ash for use in concrete by using a relatively simple apparatus.

### BRIEF DESCRIPTION OF DRAWING

FIG. 1 is a block diagram showing a configuration of a system for reforming unburned carbon-containing coal ash according to an embodiment of the present invention.

### BEST MODE FOR CARRYING OUT THE INVENTION

Hereinafter, a method for reforming unburned carbon-containing coal ash, a system for reforming unburned carbon-containing coal ash, and a method for producing fly ash for use in concrete according to an embodiment of the present invention will be described with reference to the attached drawing.

In the present embodiment, unburned carbon-containing coal ash which is an object to be reformed is unburned carbon-containing coal ash generated at a coal-fired thermal power plant.

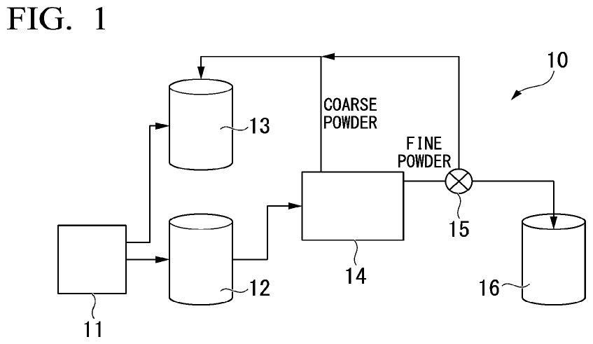

FIG. 1 is a block diagram showing a configuration of a system for reforming unburned carbon-containing coal ash according to an embodiment of the present invention.

In FIG. 1, the system for reforming unburned carbon-containing coal ash 10 includes an unburned carbon-containing coal ash receiving unit 11, a storage tank of coal ash for reforming 12 and a storage tank of coal ash for a cement raw material 13 which are connected to the unburned carbon-containing coal ash receiving unit 11, a classifying apparatus 14 connected to the storage tank of coal ash for reforming 12, an inspection unit 15 connected to the classifying apparatus 14, and a reformed coal ash storage tank 16 connected to the inspection unit 15.

The unburned carbon-containing coal ash receiving unit 11 measures L value and b value of the unburned carbon-containing coal ash in a Lab color order system. Then, unburned carbon-containing coal ash of which the L value is 54 or more and the b value is 2 or more and 10 or less is sorted.

In the Lab color order system, the L value generally represents lightness. In the unburned carbon-containing coal ash, the L value is considered to correlate with an attached amount of unburned carbon on a coal ash surface. That is, when the L value is low (lightness is low=it is close to black), the attached amount of the unburned carbon on coal ash becomes large and an MB adsorption amount increases. Therefore, in the present embodiment, the L value is set to be 54 or more. The upper limit of the L value is generally 75 or less. The L value is preferably set to be 60 or more and 70 or less, but is not limited thereto.

In the Lab color order system, the b value generally represents chromaticity toward yellow. In the unburned carbon-containing coal ash, the b value is considered to correlate with an activity of the coal ash surface and a methylene blue (MB) adsorption amount. That is, when the b value is high (the chromaticity toward the yellow is high), the MB adsorption amount is small and an activity index of coal ash is low. On the other hand, when the b value is too low, the MB adsorption amount becomes too large. The large MB adsorption amount means that it is easy to adsorb a component of a chemical admixture (an AE admixture, an AE water reducing agent, and a water reducing agent) used in cement. That is, when the MB adsorption amount becomes larger, the addition amount of the chemical admixture increases to obtain a desired amount of air. Furthermore, when the MB adsorption amount is excessively large, it is not possible to obtain the desired amount of air. Therefore, in the present embodiment, the balance between the MB adsorption amount and the activity index is considered and the b value is set to be 2 or more and 10 or less. The b value is preferably set to be 4 or more and 8 or less, but is not limited thereto.

As a method of measuring the L value and the b value of the unburned carbon-containing coal ash, a batch method (batch type) and a continuous method can be used. The batch method is a method in which a part of the unburned carbon-containing coal ash is sampled and the L value and the b value of the sampled unburned carbon-containing coal ash are measured. The continuous method is a method in which the L value and the b value are measured while continuously conveying the unburned carbon-containing coal ash by conveying means such as a belt conveyor.

The storage tank of coal ash for reforming 12 is a container for storing the unburned carbon-containing coal ash which was sorted in the unburned carbon-containing coal ash receiving unit 11 and satisfies a condition that the L value is 54 or more and the b value is 2 or more and 10 or less.

The storage tank of coal ash for a cement raw material 13 is a container for storing unburned carbon-containing coal ash which does not satisfy the condition that the L value is 54 or more and the b value is 2 or more and 10 or less.

As the classifying apparatus 14, a dry classifying apparatus is used. As the dry classifying apparatus, a centrifugal type classifying apparatus that performs classification by using a centrifugal force of particles and an inertia type classifying apparatus that performs classification by using an inertial force of particles can be used. In addition, as the centrifugal type of classifying apparatus, a forced vortex type, a semi-free vortex type, and a free vortex type can be used. The forced vortex type classifying apparatus is a classifying apparatus which includes a rotating body (also referred to as a classification rotor) inside the apparatus, and forms a vortex forcibly by rotating the rotating body at a high speed. The semi-free vortex type classifying apparatus is a classifying apparatus which includes a guide plate (also referred to as a slit) for generating a vortex inside the apparatus, instead of the rotating body. The free vortex type classifying apparatus is a classifying apparatus which blows a gas in a tangential direction inside the apparatus to generate a vortex, as typified by a cyclone. Among these classifying apparatuses, the forced vortex centrifugal type classifying apparatus is preferable. In the forced vortex centrifugal type classifying apparatus, a particle diameter of classified powder can be precisely controlled by adjusting the number of rotations of the rotating body.

In the classifying apparatus 14, the unburned carbon-containing coal ash is classified under a condition that a residue on a 45 μm sieve of reformed coal ash which has been reformed by classification is 8% by mass or less.

When the residue on a 45 μm sieve is set to a high value exceeding 8% by mass, there is a concern that a removal efficiency of coal ash to which a large amount of unburned carbon was attached may be reduced. Therefore, in the present embodiment, a classification condition is set as a condition that the residue on a 45 μm sieve of classified coal ash is 8% by mass or less. In order to increase the removal efficiency of coal ash to which a large amount of unburned carbon was attached, it is more preferable to set the condition such that the residue on a 45 μm sieve of the classified reformed coal ash is 5% by mass or less.

On the other hand, when the residue on a 45 μm sieve is set to a low value, there is a concern that a recovery rate of reformed coal ash may be excessively reduced. Therefore, in the present embodiment, a classification condition is set such that the residue on a 45 82 m sieve of the reformed coal ash which has been reformed by classification is preferably 0.5% by mass or more and particularly preferably 1.0% by mass or more.

The inspection unit 15 recovers the reformed coal ash (fine powder) which has been reformed by being classified in the classifying apparatus 14 and measures a physical property required as fly ash for use in concrete, with respect to the recovered coal ash. Examples of the physical property to be measured can include particle size, Blaine specific surface area, residue on a 45 μm sieve, L value, b value, ignition loss (ig. loss), the MB adsorption amount, and the activity index.

The reformed coal ash storage tank 16 is a container for storing the reformed coal ash which was confirmed to satisfy the physical property required as the fly ash for use in concrete by the inspection unit 15.

Next, a method for producing fly ash for use in concrete, using the system for reforming unburned carbon-containing coal ash 10 described above will be described.

First, unburned carbon-containing coal ash conveyed from a coal-fired thermal power plant is transferred to the unburned carbon-containing coal ash receiving unit 11. In the unburned carbon-containing coal ash receiving unit 11, the L value and the b value of the unburned carbon-containing coal ash in the Lab color order system are measured, and unburned carbon-containing coal ash of which the L value is 54 or more and the b value is 2 or more and 10 or less is sorted.

The unburned carbon-containing coal ash which was sorted in the unburned carbon-containing coal ash receiving unit 11 and satisfies a condition that the L value is 54 or more and the b value is 2 or more and 10 or less is transferred to the storage tank of coal ash for reforming 12 and temporarily stored.

On the other hand, unburned carbon-containing coal ash which does not satisfy the condition the L value is 54 or more and the b value is 2 or more and 10 or less is transferred to the storage tank of coal ash for a cement raw material 13 and temporarily stored. Thereafter, the unburned carbon-containing coal ash stored in the storage tank of coal ash for a cement raw material 13 is fired as a cement raw material together with other cement raw materials to form a cement clinker.

The unburned carbon-containing coal ash stored in the storage tank of coal ash for reforming 12 is transferred to the classifying apparatus 14. In the classifying apparatus 14, the unburned carbon-containing coal ash is classified under the condition that the residue on a 45 μm sieve of the reformed coal ash which has been reformed by classification is 8% by mass or less.

The reformed coal ash (fine powder) which has been reformed by classification is transferred to the inspection unit 15. The inspection unit 15 measures a physical property required as fly ash for use in concrete, with respect to the transferred coal ash.

On the other hand, the coarse powder removed in the classifying apparatus 14 is transferred to the storage tank of coal ash for a cement raw material 13.

The reformed coal ash which was confirmed to satisfy the physical property required as the fly ash for use in concrete by the inspection unit 15 is transferred to the reformed coal ash storage tank 16, and temporarily stored. Then, the reformed coal ash is taken out from the reformed coal ash storage tank 16 as the fly ash for use in concrete and used. On the other hand, the coal ash which does not satisfy the physical property required as the fly ash is transferred to the storage tank of coal ash for a cement raw material 13.

According to the method and system for reforming unburned carbon-containing coal ash of the present embodiment having the configuration as above, the unburned carbon-containing coal ash of which the L value is 54 or more and the b value is 2 or more and 10 or less is sorted and used. Therefore, the reformed coal ash has a low MB adsorption amount and a high activity index. In addition, in the present embodiment, the unburned carbon-containing coal ash is classified under the condition that the residue on a 45 μm sieve of the reformed coal ash which has been reformed by classification is 8% by mass or less. Therefore, coarse coal ash in which an attached amount of the unburned carbon is large is efficiently removed and the classified reformed coal ash is fine and has the high activity index. Therefore, the classified reformed coal ash can be effectively used as the fly ash described in JIS A 6201. Accordingly, coal ash which can be effectively used as the fly ash defined in JIS A 6201 can be obtained by a simple method without removing unburned carbon by static electricity or heating.

In addition, in the present embodiment, the unburned carbon-containing coal ash is the unburned carbon-containing coal ash generated at the coal-fired thermal power plant. Therefore, the unburned carbon-containing coal ash generated at the coal-fired thermal power plant in a large amount can be effectively used.

Furthermore, in the method for reforming unburned carbon-containing coal ash according to the present embodiment, in the classifying process, it is preferable that the unburned carbon-containing coal ash is classified under the condition that the residue on a 45 μm sieve of the reformed coal ash which has been reformed by classification is 5% by mass or less. Therefore, the reformed coal ash is surely fine and has a high activity index. Therefore, the reformed coal ash can he more effectively used as the fly ash defined in JIS A 6201.

In addition, according to the method for producing fly ash for use in concrete of the present embodiment, the method for reforming unburned carbon-containing coal ash according to the present invention described above is used as a method for reforming unburned carbon-containing coal ash. Therefore, unburned carbon-containing coal ash generated at the coal-fired thermal power plant can be made fly ash for use in concrete by using a relatively simple apparatus.

Hereinbefore, a description has been given of the embodiments of the present invention. However, the present invention is not limited thereto, and approximate modifications can be made in a range not departing from the technical spirit of the invention.

For example, in the present embodiment, the coal ash stored in the storage tank of coal ash for a cement raw material 13 is used as a cement raw material. However, the coal ash stored in the storage tank of coal ash for a cement raw material 13 may be reformed by static electricity or heating to be used as fly ash for concrete. The reformed coal ash may be added as a little admixture for cement, and may be used as fly ash for producing fly ash cement.

In addition, as the classifying apparatus, the dry classifying apparatus is used. However, a wet classifying apparatus may be used.

### EXAMPLES

Hereinafter, the present invention will be described using Examples and Comparative Examples.

### Examples 1 to 6 and Comparative Examples 1 to 7

200 kg of various coal ash generated at a plurality of coal-fired thermal power plants were received in the receiving unit. The L value and the b value of received coal ash which was received were measured by using a colorimetric color difference meter (manufactured by Nippon Denshoku Kogyo Co., Ltd., model: ZE 2000). Results thereof are shown in Table 1.

Subsequently, the received coal ash was classified by using the forced vortex centrifugal type classifying apparatus (turbo classifier, manufactured by Nisshin Engineering Co., Ltd.), and the classified coal ash (fine powder) was recovered.

A classification condition was set as a condition that the residue on a 45 μm sieve of classified coal ash is 8% by mass or less.

For the classified coal ash (fine powder or classified fly ash), the residue on a 45 μm sieve and the activity index which are quality standards defined in JIS A 6201 (fly ash for concrete), and the methylene blue (MB) adsorption amount were measured by the following method. The quality standards defined in Type II of JIS A 6201 (fly ash for concrete) include SiO₂: 45.0% or more, ignition loss (ig. loss): 5.0% or less, a moisture content: 1.0% or less, density: 1.95 g/cm³ or higher, a residue on a 45 μm sieve: 40% or less, a Blaine specific surface area: 2500 cm²/g or more, a flow value ratio: 95% or more, an activity index (material age 28 days): 80% or more, and an activity index (material age 91 days): 90% or more. Thus, regarding the reformed coal ash in which a residue on a 45 μm was 8% or less, the MB adsorption amount was 0.8 mg/g or less, and the activity index (material age 28 days) was 80% or more, reformed coal ash has a high activity as a concrete admixture, and excellent in air entrainment was determined as “A”, and the others were determined as “B”. Results thereof are shown in Table 1.

### (Residue on 45 μm Sieve)

A measurement was performed in accordance with a method defined in Annex 1 of JIS A 6201 (fly ash for concrete): a test method of a residue on a 45 μm sieve (mesh sieve method).

### (MB Adsorption Amount)

A measurement was performed in accordance with “JCAS 1-61: 2008” (test method of methylene blue adsorption amount of fly ash) of the Society of Cement.

### (Activity Index)

A measurement was performed in accordance with a method defined in JIS A 6201 (fly ash for use in concrete). In addition, a value of Table 1 is a value of 28 days of material age.

TABLE 1

| | | | Classified fly ash | | | |
|---|---|---|---|---|---|---|
| | Received coal ash | | | | Activity index | |
| | L | b | Residue on | MB adsorption | (material age: | |
| | value | value | 45 μm sieve | amount | 28 days) | |
| | (—) | (—) | (by mass) | (mg/g) | (%) | Determination |
| Example 1 | 62 | 5.7 | 5.1 | 0.3 | 82 | A |
| Example 2 | 54 | 8.1 | 6.2 | 0.7 | 84 | A |
| Example 3 | 58 | 4.2 | 4.6 | 0.5 | 87 | A |
| Example 4 | 61 | 3.6 | 4.4 | 0.4 | 83 | A |
| Example 5 | 62 | 2.3 | 6.8 | 0.7 | 84 | A |
| Example 6 | 64 | 3 | 4.3 | 0.2 | 85 | A |
| Comparative | 51 | 6.4 | 5.8 | 1 | 84 | B |
| Example 1 | | | | | | |
| Comparative | 45 | 1.9 | 6.8 | 1.1 | 83 | B |
| Example 2 | | | | | | |
| Comparative | 57 | 1.6 | 7.1 | 1.4 | 87 | B |
| Example 3 | | | | | | |
| Comparative | 55 | 1.8 | 7.2 | 1.2 | 82 | B |
| Example 4 | | | | | | |
| Comparative | 56 | 11.6 | 6.1 | 0.8 | 77 | B |
| Example 5 | | | | | | |
| Comparative | 58 | 11.3 | 5.8 | 0.5 | 79 | B |
| Example 6 | | | | | | |
| Comparative | 54 | 12.2 | 5.9 | 0.7 | 78 | B |
| Example 7 | | | | | | |

From the results in Table 1, it was confirmed that coal ash (Examples 1 to 6) obtained by classifying received coal ash of which the L value and the b value are in a range of the present invention under the condition of the present invention was well-balanced between the MB absorption amount and the activity index, and was useful as a concrete admixture defined in JIS A 6201.

On the other hand, coal ash (Comparative Examples 1 and 2) obtained by classifying received coal ash of which the L value is lower than the range of the present invention range had a large MB adsorption amount. It is presumed that this is because a large amount of carbon was attached to coal ash.

Also, coal ash (Comparative Examples 3 and 4) obtained by classifying received coal ash of which the b value is lower than the range of the present invention had a high activity index but had a large MB adsorption amount. It is presumed that this is because activity of the coal ash surface was too high.

On the other hand, coal ash (Comparative Examples 5, 6, and 7) obtained by classifying received coal ash of which the b value is higher than the range of the present invention had a small MB adsorption amount but had a low activity index. It is presumed that this is because the activity of the coal ash surface is too low.

### INDUSTRIAL APPLICABILITY

According to the present invention, it is possible to provide a method for reforming unburned carbon-containing coal ash and a system for reforming unburned carbon-containing coal ash, which can reform unburned carbon-containing coal ash generated at a coal-fired thermal power plant or the like as coal ash, which can be effectively used as fly ash for use in concrete as defined in JIS A 6201, by using a relatively simple apparatus. In addition, according to the present invention, it is possible to provide a method for producing fly ash for use in concrete, which can reform the unburned carbon-containing coal ash generated at the coal-fired thermal power plant into fly ash for use in concrete by using a relatively simple apparatus.

### REFERENCE SIGNS LIST

10 System for reforming unburned carbon-containing coal ash

11 Unburned carbon-containing coal ash receiving unit

12 Storage tank of coal ash for reforming

13 Storage tank of coal ash for cement raw material

14 Classifying apparatus

15 Inspection unit

16 Reformed coal ash storage tank

1. A method for reforming unburned carbon-containing coal ash, the method comprising:
measuring an L value and a b value of unburned carbon-containing coal ash in a Lab color order system and sorting unburned carbon-containing coal ash of which the L value is 54 or more and the b value is 2 or more and 10 or less; and
classifying the unburned carbon-containing coal ash sorted under a condition that a residue on a 45 μm sieve of reformed coal ash which has been reformed by classification is 8% by mass or less.

2. The method according to claim 1,
wherein the unburned carbon-containing coal ash is unburned carbon-containing coal ash generated at a coal-fired thermal power plant.

3. The method according to claim 1,
wherein, the unburned carbon-containing coal ash is classified under a condition that the residue on a 45 μm sieve of the reformed coal ash which has been reformed by classification is 5% by mass or less.

4. A system for reforming unburned carbon-containing coal ash, the system comprising:
a receiving unit that is configured to measure L value and b value of unburned carbon-containing coal ash in a Lab color order system and sorts unburned carbon-containing coal ash of which the L value is 54 or more and the b value is 2 or more and 10 or less; and
a classifying apparatus that is configured to classify the unburned carbon-containing coal ash sorted by the receiving unit under a condition that a residue on a 45 μm sieve of reformed coal ash which has been reformed by classification is 8% by mass or less.

5. A method for producing fly ash comprising:
the method according to claim 1.
